(19) United States
(12) Patent Application Publication
(10) Pub. No.: US 2022/0204736 A1
(43) Pub. Date: Jun. 30, 2022

(54) POLYMER MATERIAL FOR TOYS AND PREPARATION EQUIPMENT THEREOF

(71) Applicant: NINGBO BEILUN DEHENG PLASTIC PRODUCTS & MOLDS CO., LTD, Ningbo (CN)

(72) Inventor: Gang Hu, Ningbo (CN)

(21) Appl. No.: 17/405,716

(22) Filed: Aug. 18, 2021

(30) Foreign Application Priority Data
Dec. 30, 2020 (CN) 202011610868.5

(51) Int. Cl. C08L 23/12; C08L 23/06; C08K 3/40; C08K 7/14; C08K 5/29; C08K 5/12; C08K 5/00; B29C 48/04; B29C 48/40

(52) U.S. Cl. CPC C08L 23/12; C08L 23/06; C08K 3/40; C08K 7/14; C08K 5/29; B29K 2023/12; C08K 5/0066; B29C 48/04; B29C 48/40; B29K 2023/06; C08K 5/12

(57) ABSTRACT

The present invention relates to the technical field of polymer material preparation, and discloses a polymer material for toys and a preparation equipment thereof, whereby the preparation equipment of the polymer material for toys includes an open mixer main body and a twisting mechanism mounted on the open mixer main body, and the twisting mechanism includes: a fixed ring, wherein the fixed ring is fixedly installed on the top of the open mixer main body, and a mounting flange is rotatably sleeved inside the fixed ring; a rotating gear ring, wherein the rotating gear ring is fixed with the mounting flange, and a first rotating shaft and a second rotating shaft are rotatably installed inside the rotating gear ring. Through the rotation of the rotating gear ring, the preparation equipment of the polymer material for toys enables the molten mixture located between a first twisting roller and a second twisting roller to be twisted and kneaded together, facilitating the uniform mixing of the mixture. This process is easy to operate and reduces labor costs.

### TECHNICAL FIELD

The present invention relates to the technical field of polymer material preparation, in particular to a polymer material for toys and preparation equipment thereof.

### BACKGROUND ART

PP materials and PE materials are common polymer materials used to make toys. According to the different toys manufactured, the properties of the materials used to make these toys are also slightly different. Different polymer materials are usually re-melted together by using open mixers. The new material after smelting can have the characteristics of multiple materials. Open mixers are also known as open mills. A variety of raw materials may be mixed evenly and plasticized by an open mixer and finally the mixture becomes a uniform molten material for toy processing.

When an existing open mixer is used to mix the mixture, at first it is necessary to heat the rollers of the open mixer, and then pour a variety of mixtures between two rollers, so that the various mixtures can be evenly mixed. When the open mixer is mixing these mixtures, workers need to constantly re-mix the molten materials that are rolled into sheets and roll them again, and the process is repeated several times so that multiple mixtures can be evenly mixed. A lot of manpower is consumed when an existing open mixer is in use, thus increases the labor cost.

### SUMMARY OF THE INVENTION

The present invention provides a polymer material for toys and its preparation equipment thereof. An open mixer can automatically re-mix a sheet-shaped mixture through a twisting mechanism, which facilitates the uniform mixing of the mixtures and reduces labor costs. This solves the problem mentioned in the background art, wherein when an existing open mixer is used to mix the mixtures, at first it is necessary to heat the rollers of the open mixer, and then pour a variety of mixtures between two rollers, so that the various mixtures can be evenly mixed. When the open mixer is mixing these mixtures, workers need to constantly re-mix the molten materials that are rolled into sheets and roll them again, and the process is repeated several times so that multiple mixtures can be evenly mixed. A lot of manpower is consumed when an existing open mixer is in use, thus increases the labor cost.

The present invention provides the following technical solutions: a polymer material for toys, which is made of the following components by weight:

40 parts of polyethylene resin; 85 parts of polypropylene resin; 15 parts of glass fiber; 5 parts of diatomaceous earth; 2 parts of azobisisobutyronitrile; 0.8 part of a flame retardant; 0.5 part of polyepoxysuccinic acid; 0.05 part of an antioxidant;

wherein the flame retardant is a mixture of sodium tripolyphosphate, aluminum oxide, and triglycidyl isocyanurate, and the mass ratio of sodium tripolyphosphate, aluminum oxide, and triglycidyl isocyanurate is 1:1:2;

the antioxidant is tetrakis[β-(3,5-di-tert-butyl-4-hydroxyphenyl) propionic acid] pentaerythritol ester;

the polymer material for toys is prepared by the following preparation method:

S1, weigh 40 parts of polyethylene resin, 85 parts of polypropylene resin, 15 parts of glass fiber, 5 parts of diatomaceous earth, 2 parts of azobisisobutyronitrile, 0.8 part of a flame retardant, 0.5 part of polyepoxysuccinic acid and 0.05 part of an antioxidant;

S2, put the above materials into a high-speed masher and mix;

S3, place the above homogeneously mixed materials and 40 parts of polyethylene resin together in a multi-roller open mixer and mix at 170° C. for 10 minutes;

S4, the mixed materials are fed into the feeding port of a twin-screw extruder, melted and extruded by the twin-screw extruder, and pelletized to prepare a polymer material for toys.

As an optional solution of the manufacturing equipment of the polymer material for toys of the present invention, wherein: the multi-roller open mixer comprises an open mixer main body and a twisting mechanism mounted on the open mixer main body, wherein the twisting mechanism includes: a fixed ring, wherein the fixed ring is fixedly installed on the top of the open mixer main body, and a mounting flange is rotatably sleeved inside the fixed ring; a rotating gear ring, wherein the rotating gear ring is fixed with the mounting flange, and a first rotating shaft and a second rotating shaft are rotatably installed inside the rotating gear ring, the first rotating shaft is fixedly connected with a first twisting roller, and the second rotating shaft is fixedly connected with a second twisting roller, and the first twisting roller and the second twisting roller are parallel to each other.

As an optional solution of the manufacturing equipment of the polymer material for toys of the present invention, wherein: a first mounting bracket and a second mounting bracket are fixed inside the rotating gear ring, and both ends of the first rotating shaft are rotatably connected to the first mounting bracket and the second mounting bracket respectively, and both ends of the second rotating shaft are rotatably connected to the first mounting bracket and the second mounting bracket respectively, wherein a first driven gear is fixed at one end of the first rotating shaft, and a second driven gear is fixed at one end of the second rotating shaft; a third rotating shaft is rotatably installed in the rotating gear ring, one end of the third rotating shaft is fixed with a first driving gear, and the first driving gear meshes respectively with the first driven gear and the second driven gear, the other end of the third rotating shaft is fixedly connected with the second driving gear, and the second driving gear meshes with the annular tooth groove opened on the fixed ring.

As an optional solution of the manufacturing equipment of the polymer material for toys of the present invention, wherein: a first screw auger is installed on the first twisting roller, a second screw auger is installed on the second twisting roller, and the spiral direction of the first screw auger is opposite to that of the second screw auger.

As an optional solution of the manufacturing equipment of the polymer material for toys of the present invention, wherein: the first mounting bracket is provided with a first sliding groove, a first sliding block is slidably installed in the first sliding groove, and the top of the first sliding block abuts the top of the first sliding groove through a first restoring spring; the second mounting bracket is provided with a second sliding groove, and a second sliding block is slidably installed in the second sliding groove, and the top of the second sliding block abuts the top of the second sliding groove through a second restoring spring; one end of the first rotating shaft penetrates the first sliding block, the other end of the first rotating shaft penetrates the second sliding block, and the first driven gear on the first rotating shaft is an elliptical gear.

As an optional solution of the manufacturing equipment of the polymer material for toys of the present invention, wherein: an elliptical disc is fixed at one end of the first rotating shaft away from the first driven gear, and the long axis of the disc is parallel to and has the same length with the long axis of the first driven gear; the first mounting bracket is also fixed with an abutting plate, which abuts the disc, and the distance between the abutting plate and the center of the disc equals to half the length of the long axis of the disc.

As an optional solution of the manufacturing equipment of the polymer material for toys of the present invention, wherein: the fixed ring and the mounting flange are connected by balls, and the fixed ring is provided with an outer ring groove adapted to the balls, the mounting flange is provided with an inner ring groove adapted to the balls, and the inner ring groove and the outer ring groove form the accommodating space for placing the balls.

As an optional solution of the manufacturing equipment of the polymer material for toys of the present invention, wherein: a drive motor is installed on the fixed ring, a power gear is fixed on the drive shaft of the drive motor, and the power gear meshes with the rotating gear ring.

The beneficial effects of the present invention are as follow:

1. Through the rotation of the gear ring, the preparation equipment of the polymer material for toys enables the molten mixture located between the first twisting roller and the second twisting roller to be twisted and kneaded together, facilitating the uniform mixing of the mixture. This process is easy to operate and reduces labor costs.

2. In the preparation equipment of the polymer material for toys, when the rotating gear ring rotates, the second driving gear will roll in the annular tooth groove, and the gear teeth in the annular tooth groove of the second driving gear mesh, so that the third rotating shaft rotates relative to the rotating gear ring, and then, the third rotating shaft drives the first driven gear and the second driven gear through the first drive gear, and then the first twisting roller and the second twisting roller rotate in the same direction of rotation. As the spiral direction of the first screw auger and the second screw auger are different, when the first twisting roller and the second twisting roller rotate in the same direction, it is assumed that the first screw auger on the first twisting roller forms a rightward driving force on the upper half of the molten mixture, and the second screw auger on the second twisting roller forms a leftward driving force on the lower half of the molten mixture, so that the mixture can be further kneaded, which further facilitates the full mixing of the mixture.

3. In the preparation equipment of the polymer material for toys, as the molten material has a certain degree of resilience, the molten material that is kneaded together will easily recover to its original state before kneading when it leaves the twisting action of the first screw auger and the second screw auger. Refer to the figures for details. When the first driving gear drives the first driven gear, the short axis of the first driven gear is in a vertical position, and at this time, the distance between the first twisting roller and the second twisting roller is the shortest. When the short axis of the first driven gear is in a horizontal position, as shown in the figure, at this time, the distance between the first twisting roller and the second twisting roller is the shortest. Therefore, when the rotating gear ring rotates, not only the first twisting roller rotates around the axis of the first rotating shaft, and the second twisting roller rotates around the axis of the second rotating shaft, but a reciprocating motion occurs between the first twisting roller and the second twisting roller wherein the distance between the two varies while they mutually moving away from each other and approaching each other. When the first twisting roller and the second twisting roller are close to each other, the molten mixture between the two will be squeezed, causing the mixture to stably maintain the state after kneading under the squeezing action.

### DESCRIPTION OF ACCOMPANIED FIGURES

FIG. 1 is a schematic diagram of the connection structure between the open mixer main body and the twisting mechanism of the present invention.

FIG. 2 is a schematic diagram of a part of the structure of the twisting mechanism of the present invention.

FIG. 3 is a schematic diagram of a sectional structure of the twisting mechanism of the present invention.

FIG. 4 is a schematic diagram of the meshing structure of the first driven gear and the second driven gear respectively with the first driving gear in FIG. 3 of the present invention.

FIG. 5 is a schematic diagram of the sectional structure B-B in FIG. 2 of the present invention.

In the figures: 1. Open mixer main body, 2. Fixed ring, 21. Annular tooth groove, 22. Outer ring groove, 23. Gear teeth, 3. Mounting flange, 31. Inner ring groove, 4. Rotating gear ring, 5. First rotating shaft, 51. First twisting roller, 52. First driven gear, 53. First screw auger, 54. Disc, 6. Second rotating shaft, 61. Second twisting roller, 62. Second driven gear, 63. Second screw auger, 7. First mounting bracket, 71. First sliding groove, 72. First sliding block, 73. First restoring spring, 74. Abutting plate, 8. Second mounting bracket, 81. Second sliding groove, 82. Second sliding block, 83. Second restoring spring, 9. Third rotating shaft, 91. First driving gear, 92. Second driving gear, 10. Balls, 11. Drive motor, 12. Power gear.

### Detailed Implementation Method

The technical solutions in the embodiments of the present invention will be described clearly and completely in conjunction with the accompanying figures in the embodiments of the present invention. Obviously, the described embodiments are only a part of the embodiments of the present invention, rather than all the embodiments. Based on the embodiments of the present invention, all other embodiments obtained by those of ordinary skill in the art without creative work shall fall within the protection scope of the present invention.

### Embodiment

A polymer material for toys, which is made of the following components by weight:

40 parts of polyethylene resin; 85 parts of polypropylene resin; 15 parts of glass fiber; 5 parts of diatomaceous earth; 2 parts of azobisisobutyronitrile; 0.8 part of a flame retardant; 0.5 part of polyepoxysuccinic acid; 0.05 part of an antioxidant;

wherein the flame retardant is a mixture of sodium tripolyphosphate, aluminum oxide, and triglycidyl isocyanurate, and the mass ratio of sodium tripolyphosphate, aluminum oxide, and triglycidyl isocyanurate is 1:1:2;

the antioxidant is tetrakis[β-(3,5-di-tert-butyl-4-hydroxyphenyl) propionic acid] pentaerythritol ester;

the polymer material for toys is prepared by the following preparation method:

S1, weigh 40 parts of polyethylene resin, 85 parts of polypropylene resin, 15 parts of glass fiber, 5 parts of diatomaceous earth, 2 parts of azobisisobutyronitrile, 0.8 part of a flame retardant, 0.5 part of polyepoxysuccinic acid and 0.05 part of an antioxidant;

S2, put the above materials into a high-speed masher and mix;

S3, place the above homogeneously mixed materials and 40 parts of polyethylene resin together in a multi-roller open mixer and mix at 170° C. for 10 minutes;

S4, the mixed materials are fed into the feeding port of a twin-screw extruder, melted and extruded by the twin-screw extruder, and pelletized to prepare a polymer material for toys.

The prepared material has both the properties of polyethylene resin material and properties of polypropylene resin material, and the material has good flame retardancy.

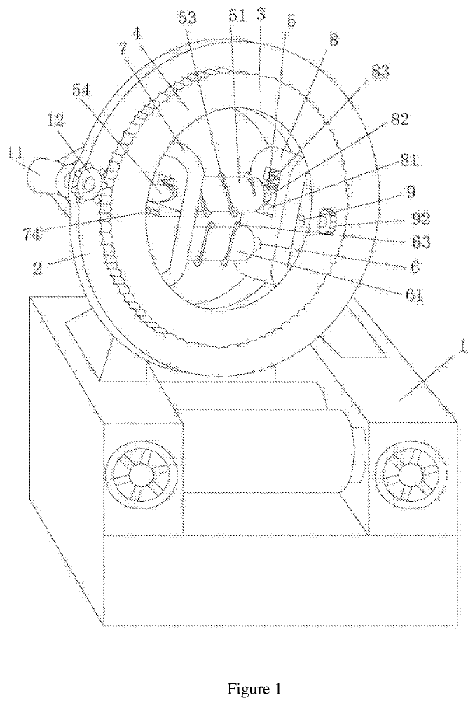

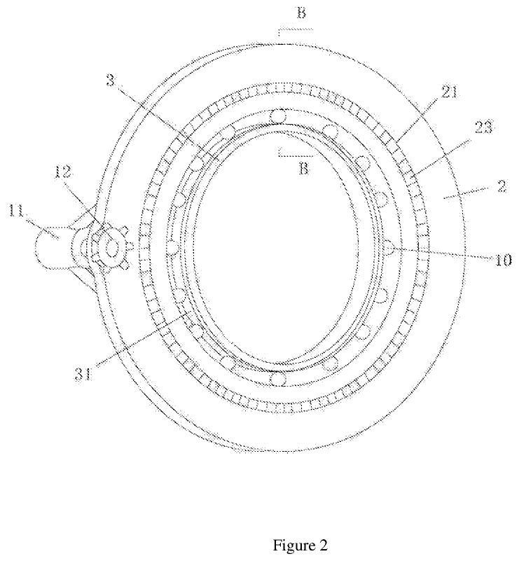

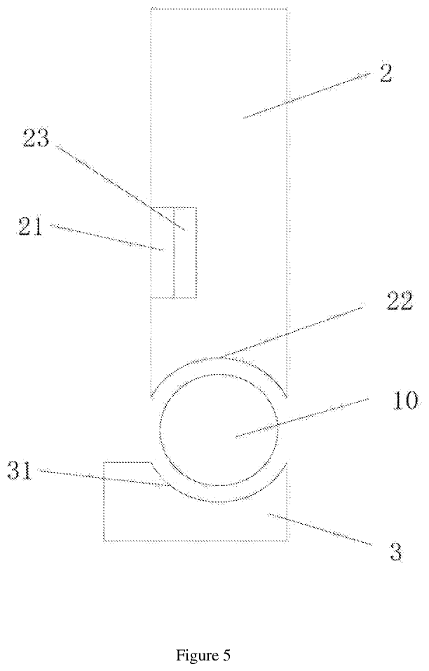

Refer to FIGS. 1-5 for details, the multi-roller open mixer comprises an open mixer main body 1 and a twisting mechanism mounted on the open mixer main body 1, wherein the twisting mechanism includes: a fixed ring 2, wherein the fixed ring 2 is fixedly installed on the top of the open mixer main body 1, and a mounting flange 3 is rotatably sleeved inside the fixed ring 2; a rotating gear ring 4, wherein the rotating gear ring 4 is fixed with the mounting flange 3, and a first rotating shaft 5 and a second rotating shaft 6 are rotatably installed inside the rotating gear ring 4, the first rotating shaft 5 is fixedly connected with a first twisting roller 51, and the second rotating shaft 6 is fixedly connected with a second twisting roller 61, and the first twisting roller 51 and the second twisting roller 61 are parallel to each other.

The rotating gear ring 4 can rotate relative to the fixed ring 2. During operation, the temperature of the rolling roller of the open mill main body 1 is raised to 170° C., and then the mixture is poured into the interval between the two rolling rollers on the open mill main body 1. The mixture is rolled to form a sheet-like structure in a molten state, similar to dough. The various mixtures on the sheet-like structure are not completely and uniformly fused together. In order to facilitate their fusion, one end of the sheet-like mixture is being passed through between the first twisting roller 51 and the second twisting roller 61, and is again put between the two rolling rollers again. As the rolling rollers crush the mixture, the mixture will form an annular structure between the first twisting roller 51 and the second twisting roller 61 and between the two rolling rollers. The rotating gear ring 4 is driven at this time, so that the rotating gear ring 4 rotates in clockwise direction as shown in FIG. 1. At this time, the first twisting roller 51 and the second twisting roller 61 located in the rotating gear ring 4 can twist and knead the sheet-shaped molten material between them, so that the molten material can be mixed together and enter the interval between the two rollers again for rolling with the driving of the rollers. After several times of rolling, the components of the mixture can be uniformly mixed together. This mixing method only requires manual feeding in the early stage. Other processes can be completely without manual participation, thus saving labor costs.

A first mounting bracket 7 and a second mounting bracket 8 are fixed inside the rotating gear ring 4, and both ends of the first rotating shaft 5 are rotatably connected to the first mounting bracket 7 and the second mounting bracket 8 respectively, and both ends of the second rotating shaft 6 are rotatably connected to the first mounting bracket 7 and the second mounting bracket 8 respectively, wherein a first driven gear 52 is fixed at one end of the first rotating shaft 5, and a second driven gear 62 is fixed at one end of the second rotating shaft 6; a third rotating shaft 9 is rotatably installed in the rotating gear ring 4, one end of the third rotating shaft 9 is fixed with a first driving gear 91, and the first driving gear 91 meshes respectively with the first driven gear 52 and the second driven gear 62, the other end of the third rotating shaft 9 is fixedly connected with the second driving gear 92, and the second driving gear 92 meshes with the annular tooth groove 21 opened on the fixed ring 2; a first screw auger 53 is installed on the first twisting roller 51, a second screw auger 63 is installed on the second twisting roller 61, and the spiral direction of the first screw auger 53 is opposite to that of the second screw auger 63.

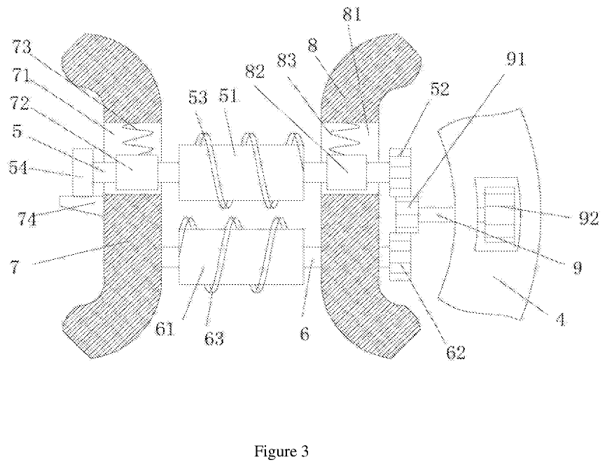

Refer to FIG. 3 for details, when the rotating gear ring 4 rotates, the second driving gear 92 will roll in the annular tooth groove 21, and the gear teeth 23 in the annular tooth groove 21 of the second driving gear 92 mesh, so that the third rotating shaft 9 rotates relative to the rotating gear ring 4, and then, the third rotating shaft 9 drives the first driven gear 52 and the second driven gear 62 through the first drive gear 91, and then the first twisting roller 51 and the second twisting roller 61 rotate in the same direction of rotation. As the spiral direction of the first screw auger 53 and the second screw auger 63 are different, when the first twisting roller 51 and the second twisting roller 61 rotate in the same direction, it is assumed that the first screw auger 53 on the first twisting roller 51 forms a rightward driving force on the upper half of the molten mixture, and the second screw auger 63 on the second twisting roller 61 forms a leftward driving force on the lower half of the molten mixture, so that the mixture can be further kneaded, which further facilitates the full mixing of the mixture. It should be noted that the kneading direction is consistent with the kneading direction of the mixture when the annular tooth groove 21 rotates.

The first mounting bracket 7 is provided with a first sliding groove 71, a first sliding block 72 is slidably installed in the first sliding groove 71, and the top of the first sliding block 72 abuts the top of the first sliding groove 71 through a first restoring spring 73; the second mounting bracket 8 is provided with a second sliding groove 81, and a second sliding block 82 is slidably installed in the second sliding groove 81, and the top of the second sliding block 82 abuts the top of the second sliding groove 81 through a second restoring spring 83; one end of the first rotating shaft 5 penetrates the first sliding block 72, the other end of the first rotating shaft 5 penetrates the second sliding block 82, and the first driven gear 52 on the first rotating shaft 5 is an elliptical gear, and the first restoring spring 73 and the second restoring spring 83 are used for pushing the first twisting roller 51 to move towards the second twisting roller 61.

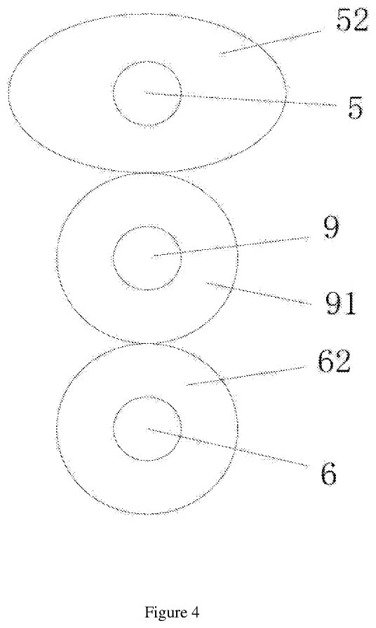

As the molten material has a certain degree of resilience, the molten material that is kneaded together will easily recover to its original state before kneading when it leaves the twisting action of the first screw auger 53 and second screw auger 63. Refer to FIG. 4 for details. When the first driving gear 91 drives the first driven gear 52, the short axis of the first driven gear 52 is in a vertical position, and at this time, the distance between the first twisting roller 51 and the second twisting roller 61 is the shortest. When the short axis of the first driven gear 52 is in a horizontal position, as shown in FIG. 4, at this time, the distance between the first twisting roller 51 and the second twisting roller 61 is the shortest. Therefore, when the rotating gear ring 4 rotates, not only the first twisting roller 51 rotates around the axis of the first rotating shaft 5, and the second twisting roller 61 rotates around the axis of the second rotating shaft 6, but a reciprocating motion occurs between the first twisting roller 51 and the second twisting roller 61 wherein the distance between the two varies while they mutually moving away from each other and approaching each other. When the first twisting roller 51 and the second twisting roller 61 are close to each other, the molten mixture between the two will be squeezed, causing the mixture to stably maintain the state after kneading under the squeezing action.

An elliptical disc 54 is fixed at one end of the first rotating shaft 5 away from the first driven gear 52, and the long axis of the disc 54 is parallel to and has the same length with the long axis of the first driven gear 52; the first mounting bracket 7 is also fixed with an abutting plate 74, which abuts the disc 54, and the distance between the abutting plate 74 and the center of the disc 54 equals to half the length of the long axis of the disc 54, thus when the first driving gear 91 drives the first rotating shaft 5 to rotate, the situation that the first rotating shaft 5 is only subjected to the upward lifting action of the first driven gear 52 is avoided, so that the first rotating shaft 5 can maintain itself parallel to the second rotating shaft 6 and keeps the reciprocating motion in vertical direction.

The fixed ring 2 and the mounting flange 3 are connected by balls 10, and the fixed ring 2 is provided with an outer ring groove 22 adapted to the balls 10, the mounting flange 3 is provided with an inner ring groove 31 adapted to the balls 10, and the inner ring groove 31 and the outer ring groove 22 form the accommodating space for placing the balls 10.

A drive motor 11 is installed on the fixed ring 2, a power gear 12 is fixed on the drive shaft of the drive motor 11, and the power gear 12 meshes with the rotating gear ring 4. The driving motor 11 is used to drive the rotating gear ring 4.

It should be noted that in this article, relational terms such as first and second are only used to distinguish one entity or operation from another entity or operation, and do not necessarily require or imply that there is any such actual relationship or sequential order between these entities or operations. Moreover, the terms “include”, “comprise” or any other variants thereof are intended to cover non-exclusive inclusion, so that a process, method, article or equipment including a series of elements not only includes those elements, but also includes other elements that are not explicitly listed, or also include elements inherent to this process, method, article or equipment.

Although the embodiments of the present invention have been shown and described, those of ordinary skill in the art can understand that various changes, modifications, substitutions and variations can be made to these embodiments without departing from the principle and spirit of the present invention. The scope of the present invention is defined by the appended claims and their equivalents.

What is claimed:

1. A polymer material for toys, characterized in that: it is made of the following components by weight:
40 parts of polyethylene resin; 85 parts of polypropylene resin; 15 parts of glass fiber; 5 parts of diatomaceous earth; 2 parts of azobisisobutyronitrile; 0.8 part of a flame retardant; 0.5 part of polyepoxysuccinic acid; 0.05 part of an antioxidant;
wherein the flame retardant is a mixture of sodium tripolyphosphate, aluminum oxide, and triglycidyl isocyanurate, and the mass ratio of sodium tripolyphosphate, aluminum oxide, and triglycidyl isocyanurate is 1:1:2;
the antioxidant is tetrakis[β-(3,5-di-tert-butyl-4-hydroxyphenyl) propionic acid] pentaerythritol ester;
the polymer material for toys is prepared by the following preparation method:
S1, weigh 40 parts of polyethylene resin, 85 parts of polypropylene resin, 15 parts of glass fiber, 5 parts of diatomaceous earth, 2 parts of azobisisobutyronitrile, 0.8 part of a flame retardant, 0.5 part of polyepoxysuccinic acid and 0.05 part of an antioxidant;
S2, put the materials in S1 into a high-speed masher and mix;
S3, place the homogeneously mixed materials in S2 and 40 parts of polyethylene resin together in a multi-roller open mixer and mix at 170° C. for 10 minutes;
S4, the mixed materials are fed into the feeding port of a twin-screw extruder, melted and extruded by the twin-screw extruder, and pelletized to prepare a polymer material for toys.

2. A preparation equipment for preparing the polymer material for toys according to claim 1, characterized in that: the multi-roller open mixer comprises an open mixer main body (1) and a twisting mechanism mounted on the open mixer main body (1), wherein the twisting mechanism includes:
a fixed ring (2), wherein the fixed ring (2) is fixedly installed on the top of the open mixer main body (1), and a mounting flange (3) is rotatably sleeved inside the fixed ring (2);
a rotating gear ring (4), wherein the rotating gear ring (4) is fixed with the mounting flange (3), and a first rotating shaft (5) and a second rotating shaft (6) are rotatably installed inside the rotating gear ring (4), the first rotating shaft (5) is fixedly connected with a first twisting roller (51), and the second rotating shaft (6) is fixedly connected with a second twisting roller (61), and the first twisting roller (51) and the second twisting roller (61) are parallel to each other.

3. The preparation equipment of the polymer material for toys according to claim 2, characterized in that: a first mounting bracket (7) and a second mounting bracket (8) are fixed inside the rotating gear ring (4), and both ends of the first rotating shaft (5) are rotatably connected to the first mounting bracket (7) and the second mounting bracket (8) respectively, and both ends of the second rotating shaft (6) are rotatably connected to the first mounting bracket (7) and the second mounting bracket (8) respectively, wherein a first driven gear (52) is fixed at one end of the first rotating shaft (5), and a second driven gear (62) is fixed at one end of the second rotating shaft (6);
a third rotating shaft (9) is rotatably installed in the rotating gear ring (4), one end of the third rotating shaft (9) is fixed with a first driving gear (91), and the first driving gear (91) meshes respectively with the first driven gear (52) and the second driven gear (62), the other end of the third rotating shaft (9) is fixedly connected with the second driving gear (92), and the second driving gear (92) meshes with the annular tooth groove (21) opened on the fixed ring (2).

4. The preparation equipment of the polymer material for toys according to claim 3, characterized in that: a first screw auger (53) is installed on the first twisting roller (51), a second screw auger (63) is installed on the second twisting roller (61), and the spiral direction of the first screw auger (53) is opposite to that of the second screw auger (63).

5. The preparation equipment of the polymer material for toys according to claim 4, characterized in that: the first mounting bracket (7) is provided with a first sliding groove (71), a first sliding block (72) is slidably installed in the first sliding groove (71), and the top of the first sliding block (72) abuts the top of the first sliding groove (71) through a first restoring spring (73);
the second mounting bracket (8) is provided with a second sliding groove (81), and a second sliding block (82) is slidably installed in the second sliding groove (81), and the top of the second sliding block (82) abuts the top of the second sliding groove (81) through a second restoring spring (83);
one end of the first rotating shaft (5) penetrates the first sliding block (72), the other end of the first rotating shaft (5) penetrates the second sliding block (82), and the first driven gear (52) on the first rotating shaft (5) is an elliptical gear.

6. The preparation equipment of the polymer material for toys according to claim 5, characterized in that: an elliptical disc (54) is fixed at one end of the first rotating shaft (5) away from the first driven gear (52), and the long axis of the disc (54) is parallel to and has the same length with the long axis of the first driven gear (52);
the first mounting bracket (7) is also fixed with an abutting plate (74), which abuts the disc (54), and the distance between the abutting plate (74) and the center of the disc (54) equals to half the length of the long axis of the disc (54).

7. The preparation equipment of the polymer material for toys according to claim 6, characterized in that: the fixed ring (2) and the mounting flange (3) are connected by balls (10), and the fixed ring (2) is provided with an outer ring groove (22) adapted to the balls (10), the mounting flange (3) is provided with an inner ring groove (31) adapted to the balls (10), and the inner ring groove (31) and the outer ring groove (22) form the accommodating space for placing the balls (10).

8. The preparation equipment of the polymer material for toys according to any of claims 2-6, characterized in that: a drive motor (11) is installed on the fixed ring (2), a power gear (12) is fixed on the drive shaft of the drive motor (11), and the power gear (12) meshes with the rotating gear ring (4).
